(19) United States
(12) Patent Application Publication
(10) Pub. No.: US 2021/0016859 A1
(43) Pub. Date: Jan. 21, 2021

(54) FISHING ACCESSORY SUPPORT STRUCTURE FOR AN INFLATABLE BOAT

(71) Applicant: INTEX INDUSTRIES XIAMEN CO. LTD., Xiamen, Fujian (CN)

(72) Inventors: Zhi Xiong Huang, Fujian (CN); Hai Lin, Fujian (CN); Zhaowei Cai, Fujian (CN); Yaw Yuan Hsu, Fujian (CN)

(21) Appl. No.: 16/987,560

(22) PCT Filed: Feb. 6, 2019
(86) PCT No.: PCT/IB2019/050953

§ 371 Date: Aug. 7, 2020

(30) Foreign Application Priority Data
Feb. 7, 2018 (CN) 201820218048.3

(51) Int. Cl. B63B 34/26; A01K 97/10; B63B 34/22

(52) U.S. Cl. CPC B63B 34/26; B63B 34/22; A01K 97/10

(57) ABSTRACT

The present disclosure provides an adjustable fishing accessory support structure for an inflatable boat. The support structure may have an adjustable width to accommodate movement of the boat. The support structure may also have an adjustable lengthwise position relative to the boat to accommodate different users. The support structure may include at least one fishing accessory mount configured to support a fishing accessory, such as a fishing rod.

### CROSS REFERENCE TO RELATED APPLICATION

This application claims priority to Chinese Application Serial No. 201820218048.3, filed Feb. 7, 2018, the disclosure of which is hereby expressly incorporated by reference herein in its entirety.

### FIELD OF THE DISCLOSURE

The present disclosure relates to fishing accessory support structures. More particularly, the present disclosure relates to adjustable fishing accessory support structures for inflatable boats, and to methods for using the same.

### BACKGROUND OF THE DISCLOSURE

Fishing rod support structures are desired to prevent fishers from having to hold their fishing rods for the entirety of their time spent fishing, thus alleviating the strain put on fishers from holding onto their fishing rods for long periods of time. Many embodiments of fishing rod support structures exist, including those that can be secured to the ground, chairs, or fishing boats. However, few embodiments exist to be secured to inflatable boats, and those that do often lack proper support. These structures are often unstable, causing the fishing rod to lean excessively or fall over when the boat rocks or flexes in the water.

### SUMMARY

The present disclosure provides an adjustable fishing accessory support structure for an inflatable boat. The support structure may have an adjustable width to accommodate movement of the boat. The support structure may also have an adjustable lengthwise position relative to the boat to accommodate different users. The support structure may include at least one fishing accessory mount configured to support a fishing accessory, such as a fishing rod.

According to an embodiment of the present disclosure, a support structure is disclosed for a fishing accessory in a boat, the boat having a first side, a second side, a floor, and a width between the first and second sides, the support structure including a support rack extending across the floor between the first side and the second side of the boat, wherein a width of the support rack is adjustable such that the width of the support rack changes as the width of the boat changes, and at least one fishing accessory mount coupled to the support rack.

According to another embodiment of the present disclosure, a support structure is disclosed for a fishing accessory in a boat, the boat having a first side, a second side, a floor, a width between the first and second sides, and a length, the support structure including a support rack extending across the floor between the first side and the second side of the boat, wherein the support rack is moveable between at least a forward position along the length of the boat and a rearward position along the length of the boat, and at least one fishing accessory mount coupled to the support rack.

According to yet another embodiment of the present disclosure, a support structure is disclosed for a fishing accessory in a boat, the support structure including a support base coupled to a boat, the support base including a first base plate including a number of first base coupling members and a second base plate including a number of second base coupling members, a first fixing arm including a first end, a second end, and a number of first arm coupling members at the second end, wherein the first arm coupling members are configured to removably couple with the first base coupling members for coupling the first fixing arm to the first base plate, the number of first base coupling members exceeding the number of first arm coupling members, a second fixing arm including a first end, a second end, and a number of second arm coupling members at the second end, wherein the second arm coupling members are configured to removably couple with the second base coupling members for coupling the second fixing arm to the second base plate, the number of second base coupling members exceeding the number of second arm coupling members, a connecting rod including a first end and a second end, wherein the first end of the first fixing arm is adjustably coupled to the first end of the connecting rod, such that an overlap distance between the first arm end and the first end of the connecting rod is adjustable, and a locking mechanism configured to fixedly couple the first end of the second fixing arm to the second end of the connecting rod, such that an overlap distance between the first end of the second fixing arm and the second end of the connecting rod is fixed.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 illustrates a perspective view of an inflatable boat with an exemplary fishing accessory support structure, the support structure including a support base coupled to the inflatable boat, a support rack, and a fishing rod mount coupled to the support rack;

FIG. 2 illustrates a perspective view of the inflatable boat of FIG. 1, illustrating the support structure without the fishing rod mount;

FIG. 3 illustrates a perspective view of the fishing rod mount coupled to the support rack of FIG. 1;

FIG. 4 illustrates a partially exploded, perspective view of the support structure of FIG. 3 with the fishing rod mount detached from the support rack;

FIG. 5 illustrates an exploded, perspective view of the support rack of FIG. 4;

FIG. 6 illustrates a partially exploded, perspective view of the support rack of FIG. 5 and the support base of FIG. 2;

FIG. 7 illustrates a partially exploded, perspective view of the support rack being coupled to the support base;

FIG. 8 illustrates a simplified, rear view of the support rack with a short overlap distance to accommodate a stretched boat configuration; and

FIG. 9 illustrates a simplified, rear view of the support rack with a longer overlap distance than FIG. 8 to accommodate a compacted boat configuration.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

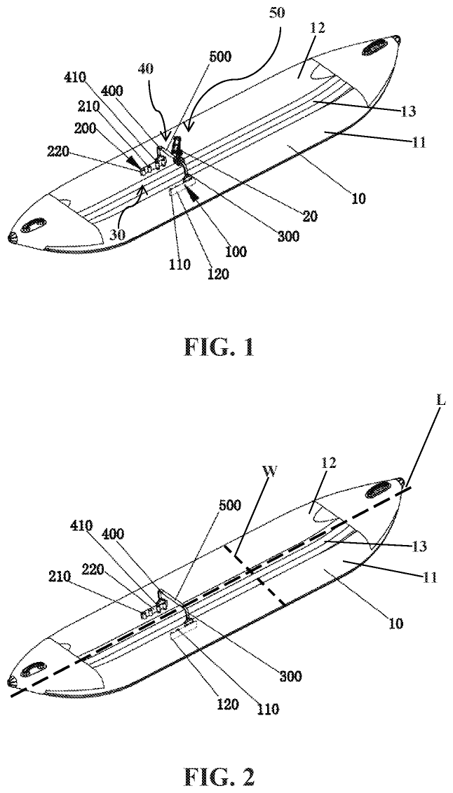

Referring to FIGS. 1-2, a support structure 50 with at least one fishing accessory mount is provided for supporting a corresponding fishing accessory in a boat 10. The illustrative fishing accessory mount is a fishing rod mount 20 configured to support a user's fishing rod (not shown). The fishing accessory mount may be selectively installed, as the support structure 50 is shown with the fishing rod mount 20 (FIG. 1) and without the fishing rod mount 20 (FIG. 2). The support structure 50 may include other fishing accessory mounts, instead of or in addition to the illustrative fishing rod mount 20, to support other fishing accessories, such as a fish finder, a depth finder, and/or a radio, for example.

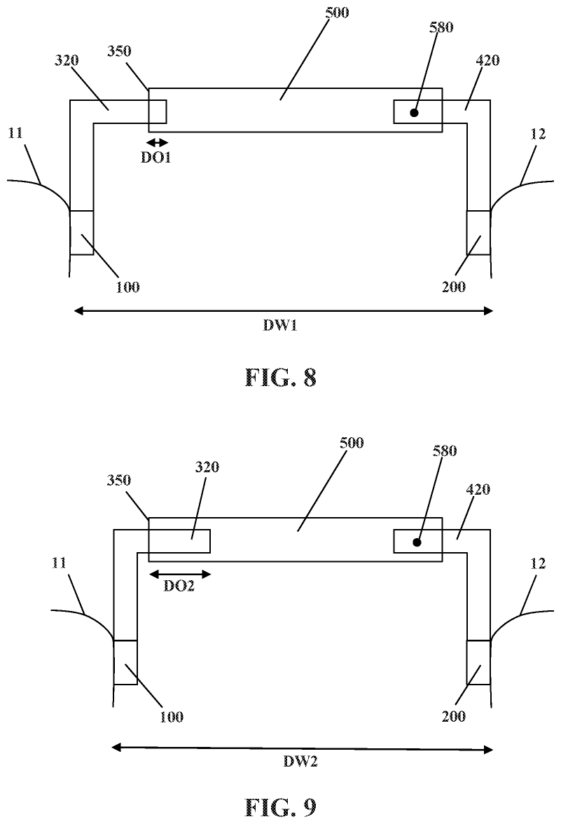

The illustrative boat 10 of FIGS. 1-2 is a kayak including a first wall 11, a second wall 12, and a floor 13 therebetween, and extends along a length L, and a width W. Boat 10 may be least partially inflatable and may include one or more valves (not shown) configured to selectively inflate and/or deflate first wall 11, first wall 12, and/or any other inflatable portions of boat 10. Boat 10 may be made of a flexible, waterproof material, such as PVC, a waterproof coated fabric, or another suitable material. Floor 13 of boat 10, in particular, may be sufficiently flexible to bend as boat 10 travels across uneven water. For example, floor 13 may bend upward causing boat 10 to take on a stretched configuration between walls 11, 12 (FIG. 8), bend downward causing boat 10 to take on a compacted configuration between walls 11, 12 (FIG. 9), or remain flat causing boat 10 to take on a resting configuration between walls 11, 12. In operation, the user would sit behind the support structure 50 while facing the front of the boat 10 with his or her legs extending beneath the support structure 50 and across floor 13.

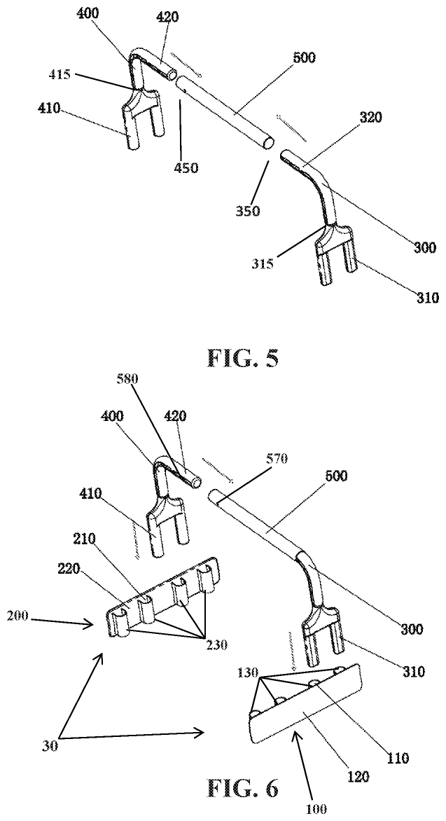

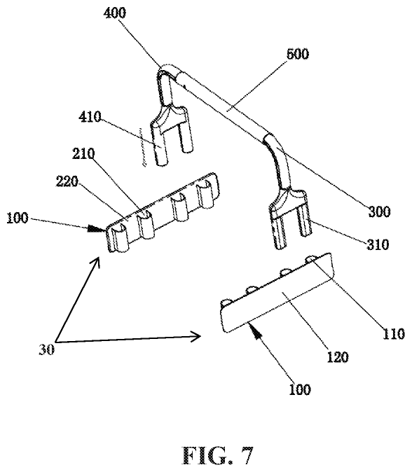

In addition to the fishing rod mount 20, the support structure 50 comprises a support rack 40 and a support base 30. Support rack 40 comprises a first fixing arm 300, a second fixing arm 400, and an intermediate connecting rod 500. Support structure 50 is coupled to boat 10 such that connecting rod 500 lies horizontally along its longitudinal axis, at or above a height of walls 11 and 12, and substantially parallel to floor 13. Connecting rod 500 extends between first fixing arm 300 and second fixing arm 400. A user's legs extend beneath connecting rod 500 when the user is seated in the boat 10 and support structure 50 is in use. Connecting rod 500 has a first end 350 and a second end 450 to receive first fixing arm 300 and second fixing arm 400, respectively. Support base 30 comprises a first fixing base 100 and a second fixing base 200. In the illustrated embodiment, support rack 40 can be assembled by coupling the first fixing arm 300 and the second fixing arm 400 to first and second ends 350 and 450 of the connecting rod 500, respectively (FIG. 5). Support rack 40 can then be coupled to support base 30 to assemble the support structure 50 (FIG. 7).

In the illustrated embodiment, first fixing base 100 is coupled to the first wall 11 of the boat 10, and second fixing base 200 is coupled to the second wall 12 of the boat 10. First fixing base 100 and second fixing base 200 may be permanently coupled to the boat 10 via high frequency welding, adhesive, or fasteners. In other embodiments, first fixing base 100 and second fixing base 200 may be removably coupled to the boat 10 via thread gluing, press buttons, zippers, clips, latches, or other removable coupling means. Such removable coupling means would allow quick assembly and disassembly for efficient storage.

First fixing base 100 of support base 30 is spaced an appropriate distance from second fixing base 200 of support base 30 to couple with the support rack 40, which spans across floor 13 of the boat 10. In one embodiment, first fixing base 100 and second fixing base 200 of support base 30 are composed of PVC or some other semi-rigid material, such as another type of plastic, metal, rubber, or other rigid or semi-rigid materials. Additionally, first fixing base 100 and second fixing base 200 of support base 30 may be constructed of a waterproof material or covered in a waterproof coating. First fixing base 100 and second fixing base 200 of support base 30 may also be coated or covered with a waterproofing material to prevent damage over time or to maintain the structural integrity of support base 30.

First fixing base 100 includes a first fixing board 120 and at least one of a first base coupling member 110. Similarly, second fixing base 200 includes a second fixing board 220 and at least one of a second base coupling member 210. In the illustrated embodiment, support base 30 has four first base coupling members 110 and four second base coupling members 210, but any number of at least one first base coupling members 110 and second base coupling members 210 may be used. The first base coupling members 110 and second base coupling members 210 align across the boat 10 such that each first base coupling member 110 is across the width W of the boat 10 from a corresponding second base coupling member 210. In other embodiments, first base coupling members 110 may be offset from second base coupling members 210 in order to alter the angle at which connecting rod 500 lies across floor 13 of boat 10. In the illustrated embodiment, first and second base coupling members 110 and 210 are formed by hollow tubes 130 and 230 coupled to first fixing board 120 and second fixing board 220, respectively. In other embodiments, base coupling members 110 and 210 may comprise protrusions coupled to first and second fixing boards 120 and 220, grooves or holes formed directly in first fixing board 120 and second fixing board 220, or any other means of coupling with fixing arms 300 and 400.

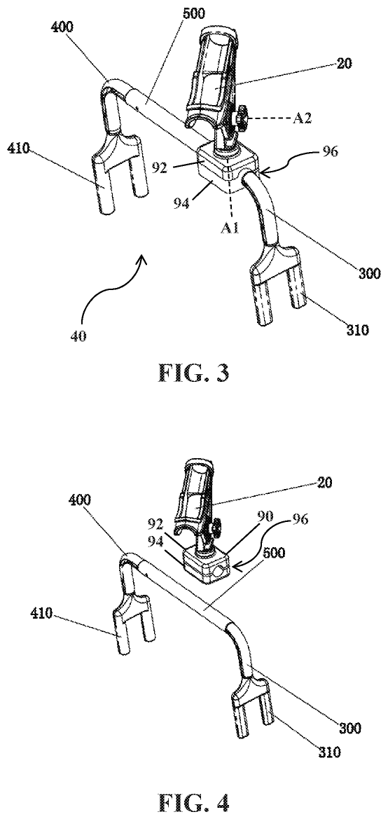

Referring to FIGS. 3-5, support rack 40 is shown with a fishing rod mount 20 attached to connecting rod 500 (FIG. 3) and with the fishing rod mount 20 detached from connecting rod 500 (FIG. 4). In the illustrated embodiment, first fixing arm 300 is L-shaped and comprises a first end 320 and at least one of a first arm coupling member 310 at a second end 315. Second fixing arm 400 is L-shaped and comprises a first end 420 and at least one of a second arm coupling member 410 at a second end 415. In other embodiments, first and second fixing arms 300 and 400 may be other shapes in order to facilitate different positions of connecting rod 500 relative to boat 10.

First arm coupling members 310 extend vertically downward from the first end 320 of first fixing arm 300 and are designed to be removably coupled to first base coupling members 110 of first fixing base 100. Similarly, second arm coupling members 410 extend vertically downward from the first end 420 of the second fixing arm 400 and are designed to be removably coupled to second base coupling members 210 of second fixing base 200. It is also within the scope of the present disclosure for first fixing arm 300 and/or second fixing arm 400 to be permanently coupled to the respective first fixing base 100 and/or second fixing base 200. In the illustrated embodiment, support rack 40 is designed such that, when assembled and coupled to the boat 10, connecting rod 500 lies horizontally along its longitudinal axis, above floor 13 of the boat 10, and spans between first fixing arm 300 and second fixing arm 400 across the width W of the boat.

In the illustrated embodiment, two first arm coupling members 310 and two second arm coupling members 410 are shown. In other embodiments, any number of at least one first arm coupling members 310 and second arm coupling members 410 may be used to removably couple first fixing arm 300 and second fixing arm 400 with first fixing base 100 and second fixing base 200, respectively. First arm coupling members 310 and second arm coupling members 410 are spaced apart such that they can be coupled to first base coupling members 110 and second base coupling members 210, respectively. In the illustrated embodiment, the number of first base coupling members 110 and second base coupling members 210 is greater than the number of first arm coupling members 310 and second arm coupling members 410, respectively, in order to give the user multiple options for placement of the support rack 40 into the support base 30 and to increase support for the support rack 40. In other embodiments, the number of first base coupling members 110 and second base coupling members 210 may be less than or equal to the number of first arm coupling members 310 and second arm coupling members 410, respectively.

In the illustrated embodiment, fishing rod mount 20 is removably coupled to connecting rod 500 with a latching mechanism 90. Latching mechanism 90 comprises an upper bracket 92, a lower bracket 94, and a hole 96 between the two brackets 92, 94 along the length of the mechanism to receive connecting rod 500. In other embodiments, fishing rod mount 20 may be removably coupled to connecting rod 500 with screws, buttons, straps, or any other fastening means. Fishing rod mount 20 may be capable of removably supporting the user's fishing rod during use. Fishing rod mount 20 may be rotatable about one or more axes A1, A2 so the user may move the supported fishing rod relative to the boat 10.

Referring to FIG. 5, first end 320 of first fixing arm 300 is designed to couple with first end 350 of connecting rod 500. Similarly, second end 420 of second fixing arm 400 is designed to couple with second end 450 of connecting rod 500. In the illustrated embodiment, first fixing arm 300 is bent in an L-shape such that first end 320 of first fixing arm 300 is approximately perpendicular to second end 315 of first fixing arm 300. Similarly, second fixing arm 400 is bent in an L-shape such that first end 420 of second fixing arm 400 is approximately perpendicular to second end 415 of second fixing arm 400. In other embodiments, the shape of first and second fixing arms 300 and 400 can be altered to adjust the angle between first ends 320 and 420, and second ends 315 and 415, of first and second fixing arms 300 and 400.

In the illustrated embodiment, connecting rod 500 has a larger diameter than the first ends 320 and 420 of first and second fixing arms 300 and 400 so that fixing arms 300 and 400 are coupled to first and second ends 350 and 450 of connecting rod 500 by inserting the first end 320 of first fixing arm 300 into first end 350 of connecting rod 500, and inserting first end 420 of second fixing arm 400 into second end 450 of connecting rod 500. In other embodiments, the connecting rod 500 may have a smaller diameter than first ends 320 and 420 of first and second fixing arms 300 and 400 so that the first end 350 of connecting rod 500 would be inserted into first end 320 of first fixing arm 300, and second end 450 of connecting rod 500 would be inserted into first end 420 of second fixing arm 400. In yet other embodiments, fixing arms 300 and 400 may be directly or indirectly coupled to connecting rod 500 by insertion, interlocking components, screws, or any other coupling means.

Referring to FIG. 5-6, first fixing arm 300 and second fixing arm 400 are coupled to the first and second ends 350 and 450, respectively, of connecting rod 500. In the illustrated embodiment, a locking mechanism is provided comprising a locking protrusion 580 (e.g., a spring-loaded locking ball) and locking slot 570 in order to secure second fixing arm 400 into connecting rod 500. Locking slot 570 is designed to receive the locking protrusion 580. Locking protrusion 580 can be pushed into second fixing arm 400 so that the surface of fixing arm 400 is roughly flush with the surface of the locking protrusion 580 and the first end 420 of second fixing arm 400 may slide within connecting rod 500. Once the locking protrusion 580 reaches the locking slot 570, the locking protrusion 580 snaps into the locking slot 570, securing the second end 420 of fixing arm 400 into the connecting rod 500.

In other embodiments, connecting rod 500 may include locking protrusion 580 and fixing arm 400 may include locking slot 570. In other embodiments, the locking mechanism may comprise a screw, a lock catch and groove, a tight-fitting structure, or similar mechanism. In other embodiments, second fixing arm 400 may be fixedly coupled to second end 450 of connecting rod 500 by means that do not require a locking mechanism, including making the second fixing arm 400 and connecting rod 500 one piece. In the illustrated embodiment, first end 320 of first fixing arm 300 is not disposed with a locking mechanism and is adjustably coupled to connecting rod 500 in a telescopic manner. This adjustable coupling allows an overlap distance between first end 320 of first fixing arm 300 and connecting rod 500 to vary, allowing the width of the support structure 50 to adjust to the changing width W of the boat 10 as the flexible boat material bends during use.

Referring to FIG. 8-9, the first end 320 of first fixing arm 300 is shown at two different overlap distances with first end 350 of connecting rod 500. A short overlap distance DO1 (FIG. 8) may accommodate a stretched configuration of boat 10, where the distance DW1 between walls 11 and 12 is greater than the distance between walls 11 and 12 would be in a resting configuration. A long overlap distance DO2 (FIG. 9) may accommodate a compacted configuration of boat 10, wherein the distance DW2 between walls 11 and 12 is less than the distance between walls 11 and 12 in the resting configuration. An intermediate overlap distance (not shown) between D1 and D2 may accommodate the resting configuration of boat 10. Connecting rod 500, first end 320 of first fixing arm 300, and first end 420 of second fixing arm 400 may comprise keys and grooves or other complimentary features to better facilitate connecting the components together and inhibiting rotation between the components.

In other embodiments, first fixing arm 300 may be fixedly coupled to connecting rod 500, and second fixing arm 400 may be adjustably coupled to connecting rod 500. Furthermore, both first fixing arm 300 and second fixing arm 400 may be adjustably coupled to connecting rod 500. First fixing arm 300 and second fixing arm 400 may be directly or indirectly coupled to connecting rod 500. In still other embodiments, connecting rod 500 may be fixedly coupled to both first fixing arm 300 and second fixing arm 400 with connecting rod 500 having a telescoping section therebetween.

In the illustrated embodiment, support rack 40 is composed of PVC or some other semi-rigid material, such as another type of plastic, metal, hard rubber, or any other rigid or semi-rigid material. Furthermore, support rack 40 may be composed of waterproof material or covered in a waterproof coating to prevent damage over time or to maintain the structural integrity of the support rack 40.

Referencing FIG. 6-7, support rack 40 is removably coupled to the support base 30 by coupling first arm coupling members 310 to first base coupling members 110 and second arm coupling members 410 to second base coupling members 210. For embodiments in which the number of first arm coupling members 310 and second arm coupling members 410 are less than the number of first base coupling members 110 and second base coupling members 210, support rack 40 may be coupled to a plurality of different corresponding positions, such as a forward position in the two forward-most base coupling members 110, 210, an intermediate position in the two middle base coupling members 110, 210, or a rearward position in the two rearward-most base coupling members 110, 210. Such embodiments provide multiple options for coupling the support rack 40 to the support base 30 to accommodate different users.

In the illustrated embodiment, arm coupling members 310 and 410 are protrusions and base coupling members 110 and 210 are slots, where arm coupling members 310 and 410 are inserted into base coupling members 110 and 210. In other embodiments, arm coupling members 310 and 410 may be slots, grooves, holes, or any other removable coupling means, and base coupling members 110 and 210 may be protrusions, grooves, holes, or any other removable coupling means.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A support structure for a fishing accessory in a boat, the boat having a first side, a second side, a floor, and a width between the first and second sides, the support structure comprising:
a support rack extending across the floor between the first side and the second side of the boat, wherein a width of the support rack is adjustable such that the width of the support rack changes as the width of the boat changes; and
at least one fishing accessory mount coupled to the support rack.

2. The support structure of claim 1, wherein the support rack comprises a first fixing arm, a second fixing arm, and a connecting rod, wherein the first fixing arm is adjustably coupled to a first end of the connecting rod and the second fixing arm is coupled to a second end of the connecting rod, whereby an overlap distance between the first fixing arm and the first end of the connecting rod is adjustable to adjust the width of the support rack.

3. The support structure of claim 2, wherein the fishing accessory mount is removably coupled to the connecting rod through a latching mechanism, the latching mechanism comprising an upper bracket, a lower bracket, and a hole between the upper bracket and the lower bracket along a length of the latching mechanism to receive the connecting rod.

4. The support structure of claim 2, further comprising a support base comprising:
a first base plate coupled to the first side of the boat and the first fixing arm; and
a second base plate coupled to the second side of the boat and the second fixing arm.

5. The support structure of claim 4, wherein the support base further comprises a number of base coupling members and each of the first and second fixing arms comprises a number of arm coupling members, such that the first and second fixing arms are removably coupled to the support base through the base coupling members and the arm coupling members.

6. The support structure of claim 5, wherein the number of base coupling members is greater than the number of arm coupling members.

7. The support structure of claim 2, further comprising a locking mechanism that fixedly couples the second fixing arm to the second end of the connecting rod such that an overlap distance between the second fixing arm and the second end of the connecting rod is fixed.

8. The support structure of claim 1, wherein the first and second sides of the boat are inflatable.

9. The support structure of claim 1, wherein the width of the boat changes as the floor bends upward and downward.

10. The support structure of claim 1, wherein the at least one fishing accessory mount is a fishing rod mount configured to support a fishing rod, the fishing rod mount having at least one axis of rotation relative to the boat.

11. A support structure for a fishing accessory in a boat, the boat having a first side, a second side, a floor, a width between the first and second sides, and a length, the support structure comprising:
a support rack extending across the floor between the first side and the second side of the boat, wherein the support rack is moveable between at least a forward position along the length of the boat and a rearward position along the length of the boat; and
at least one fishing accessory mount coupled to the support rack.

12. The support structure of claim 11, wherein the support rack is also moveable to an intermediate position between the forward and rearward positions.

13. The support structure of claim 11, wherein:
the support rack comprises:
a first fixing arm having a first end and a second end with at least one first arm coupling member;
a second fixing arm having a first end and a second end with at least one second arm coupling member; and
a connecting rod having a first end coupled to the first end of the first fixing arm and a second end coupled to the first end of the second fixing arm, the connecting rod extending across a floor of the boat and substantially parallel to the width of the boat; and
a support base comprises:
a first base plate coupled to the first side of the boat and having a plurality of first base coupling members arranged along the length of the boat and removably coupled to the at least one first arm coupling member, wherein the number of first base coupling members exceeds the number of first arm coupling members; and
a second base plate coupled to the second side of the boat and having a plurality of second base coupling members arranged along the length of the boat and removably coupled to the at least one second arm coupling member, wherein the number of second base coupling members exceeds the number of second arm coupling members.

14. The support structure of claim 13, wherein the support rack has two first arm coupling members, two second arm coupling members, four first base coupling members, and four second base coupling members.

15. The support structure of claim 13, wherein the first end of the first fixing arm is adjustably coupled to the first end of the connecting rod, such that an overlap distance between the first end of the first fixing arm and the first end of the connecting rod is adjustable.

16. The support structure of claim 13, wherein the first end of the second fixing arm is fixedly coupled the second end of the connecting rod, such that an overlap distance between the first end of the second fixing arm and the second end of the connecting rod is fixed.

17. The support structure of claim 13, wherein the first and second fixing arms are L-shaped, such that the first end of the first fixing arm and the first end of the second fixing arm extend substantially parallel to the width of the boat, and the first and second arm coupling members extend vertically relative to the floor of the boat.

18. The support structure of claim 13, wherein the first and second arm coupling members are insert protrusions and the first and second base coupling members are receiving slots, the insert protrusions configured to be removably inserted into the receiving slots.

19. The support structure of claim 11, wherein the at least one fishing accessory mount is a fishing rod mount configured to support a fishing rod, the fishing rod mount having at least one axis of rotation relative to the boat.

20. A support structure for a fishing accessory in a boat, the support structure comprising:
a support base coupled to a boat, the support base comprising a first base plate comprising a number of first base coupling members and a second base plate comprising a number of second base coupling members;
a first fixing arm comprising a first end, a second end, and a number of first arm coupling members at the second end, wherein the first arm coupling members are configured to removably couple with the first base coupling members for coupling the first fixing arm to the first base plate, the number of first base coupling members exceeding the number of first arm coupling members;
a second fixing arm comprising a first end, a second end, and a number of second arm coupling members at the second end, wherein the second arm coupling members are configured to removably couple with the second base coupling members for coupling the second fixing arm to the second base plate, the number of second base coupling members exceeding the number of second arm coupling members;
a connecting rod comprising a first end and a second end, wherein the first end of the first fixing arm is adjustably coupled to the first end of the connecting rod, such that an overlap distance between the first arm end and the first end of the connecting rod is adjustable; and
a locking mechanism configured to fixedly couple the first end of the second fixing arm to the second end of the connecting rod, such that an overlap distance between the first end of the second fixing arm and the second end of the connecting rod is fixed.

21. The support structure of claim 20, wherein the first fixing arm, the second fixing arm, and the connecting rod are keyed together to inhibit rotation.

22. The support structure of claim 20, wherein the connecting rod has a larger diameter than the first ends of the first and second fixing arms, such that when coupled together the first end of the first fixing arm is inserted into the first end of the connecting rod and the first end of the second fixing arm is inserted into the second end of the connecting rod.
